(19) United States
(12) Patent Application Publication
(10) Pub. No.: US 2005/0154688 A1
(43) Pub. Date: Jul. 14, 2005

(54) Automated performance monitoring and adaptation system

(76) Inventors: George Bolt, Hampshire (GB); John Manslow, Hampshire (GB)

Correspondence Address: KNOBBE MARTENS OLSON & BEAR LLP, 2040 MAIN STREET, FOURTEENTH FLOOR, IRVINE, CA, 92614, US

(21) Appl. No.: 10/987,451

(22) Filed: Nov. 12, 2004

Related U.S. Application Data
(63) Continuation of application No. PCT/AU03/00577, filed on May 13, 2003.

(30) Foreign Application Priority Data
May 13, 2002 (GB) 0210938.7

(51) Int. Cl. G06F 15/18

(52) U.S. Cl. 706/14; 706/25; 714/1

(57) ABSTRACT

An event detection system with an automatic performance monitoring and adaptation system is disclosed. The system includes an event detection engine and a performance assessor. The event detection engine generates an alert if the specified event is suspected. An alert investigation team investigates if the alert is real of false. The performance assessor is configured to monitor the rate at which alerts and/or false alerts are generated by the event detection engine and to perform certain actions if the rate of alerts and/or false alerts falls outside a configurable range or crosses a threshold.

### RELATED APPLICATIONS

This application is a continuation application, and claims the benefit under 35 U.S.C. §§ 120 and 365 of PCT Application No. PCT/AU03/00577, filed on May 13, 2003 and published Nov. 20, 2003, in English, which is hereby incorporated by reference.

### BACKGROUND OF INVENTION

1. Field of the Invention

The present invention relates to an automatic performance monitoring and adaptation system for adapting an event detection system to improve system performance.

2. Description of the Related Technology

Fraud is a serious problem in modem telecommunications systems, and can result in revenue loss by the telecommunications service provider, reduced operational efficiency, and increased subscriber chum. In the highly competitive telecommunications sector, any provider that can reduce revenue loss resulting from fraud—either by its prevention or early detection—has a significant advantage over its competitors.

To minimize the impact of fraud, complex fraud detection systems are frequently employed, which are typically composed of large numbers of manually configured components. For example, many systems contain hundreds of hand-written rules that examine the system's input for known indicators of fraudulent activity. Terms within the antecedents of individual rules form yet more components that interact to determine the outcome of applying each rule. For example, the antecedent of the rule ‘IF call duration is greater than 120 minutes AND call destination is an international number THEN call is fraudulent’ consists of two components that interact to determine whether the rule fires. Most modem fraud detection systems support their rule-based components with other algorithms, such as scorecards (designed, for example, to estimate the chance that individual calls are fraudulent), and change detection algorithms (designed to highlight suspicious changes in behaviour).

Patterns in the behaviour of users of a telecommunications network change gradually as their fashions, habits, and socioeconomic environment change. The introduction of new products also changes behaviour by encouraging and facilitating new ways of using the network. For example, the growth of the Internet has led to a gradual increase in the number of long calls made by domestic subscribers to telecommunications services. These changes cause the performance of automated fraud detection systems to degrade with time, with increasingly large number of false alarms being generated, and increasingly large numbers of frauds being missed. This degradation is frequently ignored, or, according to present best practice, avoided by regular modifications to the fraud detection engine's configuration. Such reconfiguration is time consuming and expensive, however, and increases the risk of introducing errors.

Most fraud detection systems consist of at least two subsystems—a fraud detection engine (FDE), which analyzes incoming data for evidence of fraudulent behaviour (in response to which it generates alerts), and an alert investigation team (AIT), which investigates the causes of the alerts to determine whether they were caused by an actual fraud. The data that the fraud detection engine monitors would typically be a call data record (CDR) stream within which descriptions of the characteristics of calls made on a telecommunications network appear shortly after their termination. A section of a real call data record is given in Table 1.

TABLE 1

| CDR Field | Value |
|---|---|
| A_NO | 11484XXXX |
| B_NO | 11789XXXX |
| B_TY | 2 |
| CCU | 1 |
| CD | 92 |
| Sdate | 05/05/98 |
| Stime | 11:13:28 |

The fields contained in the call data record are (from top to bottom) A-number (the number of the phone from which the call was made), B-number (the number to which the call was made), B-number type (whether the call was local, national, international, etc. encoded as a number), the call's cost, its duration, and the date and time at which it started. Note that the four rightmost digits of the A- and B-numbers have been masked with ‘X’s to conceal the identities of the calling and called parties. The stream may also contain additional information, such as customer data (which can provide a customer's address, payment history, etc.). The fraud detection engine usually contains many components, including change detection algorithms (which search for the changes in behaviour that occur during periods of fraudulent activity), rules (which look for known characteristics of fraudulent behaviour), and data-driven classifiers such as neural networks (which can be trained using examples of real frauds to provide an indication of the likelihood that a fraud is in progress).

In addition to the fraud detection engine and alert investigation team, many systems add a configuration and administration team which is responsible for the initial configuration of the system (defining its rules, setting its sensitivity, deciding what data it will analyze, etc and it's maintenance through continual modification of the configuration to prevent to a slow deterioration of it's fault detection performance etc.).

### SUMMARY OF CERTAIN INVENTIVE ASPECTS OF THE INVENTION

In accordance with a first aspect of the present invention there is provided a performance monitoring and adaptation system comprising: a performance assessor configured to monitor the rate at which alerts are generated by an event detection system and to perform a first set of actions if the rate crosses a threshold.

In accordance with a second aspect of the present invention there is provided an event detection system comprising: an event detection engine that generates an alert if the event is suspected; and a performance assessor configured to monitor the rate at which alerts are generated by the event detection engine and to perform a first set of actions if the rate crosses a threshold.

In one embodiment, the threshold is an end of a configurable range, wherein the first set of actions is triggered if the rate falls outside of the range.

In one embodiment, a configurable number of thresholds may be provided, each of which trigger a respective set of actions if the rate of alerts crosses the respective threshold. In one embodiment, the set of actions includes one or more actions.

In one embodiment, the action of the first set of actions performed is determined by the direction in which the rate of alerts crosses the threshold.

In one embodiment, the system further comprises a second performance assessor configured to monitor the rate at which false alerts are generated by the event detection system to perform a second set of actions if the rate of false alerts crosses a second threshold. False alerts are false positives, false negatives or both.

In one embodiment, the second threshold is an end of a second configurable range, wherein the second set of actions is triggered if the rate of false alerts falls outside the second configurable range.

In one embodiment, a configurable number of thresholds may be provided, each of which trigger a respective set of actions if the rate of false alerts crosses the respective threshold.

In one embodiment, the action of the second set of actions performed is determined by the direction in which the rate of false alerts crosses the second threshold.

In one embodiment, the first set of actions includes a first alert flood action conducted when the rate of alerts crosses above a configurable first upper trigger rate. In one embodiment, the first set of actions includes a first alert drought action which occurs when the rate of alerts crosses below a first configurable lower trigger rate.

In one embodiment, a lower reset threshold is built into the first lower trigger rate, such that the rate of alerts must rise above the first lower trigger rate added to a first lower threshold amount before the lower trigger will re-activate the first alert drought action after a previous activation. In one embodiment, an upper reset threshold is built into the first upper trigger rate, such that the rate of alerts must fall below the first upper trigger rate less a first upper reset threshold amount before the upper trigger will re-activate the first alert flood action after a previous activation.

In one embodiment, the second set of actions includes a second alert flood action which is triggered when a function of the false alert rate rises above a configurable second upper trigger rate. In one embodiment, the second set of actions includes a second alert drought action which is triggered when a function of the rate of false alerts are under a second configurable lower trigger rate. In one embodiment, the function is a moving average function.

In one embodiment, a lower reset threshold is built into the range of rate of false alerts, such that the moving average of the rate of false alerts must rise above the second lower trigger rate added to a second lower reset threshold amount before the lower trigger will re-activate the second drought alert action.

In one embodiment, an upper reset threshold is built into the range or rates of false alerts, such that the moving average of the rate of false alerts must fall below the second upper trigger rate less a second upper reset threshold amount before the second upper trigger will re-activate the second alert flood action.

In one embodiment, the actions modify the event detection engine. Preferably the actions modify a respective parameter of the event detection engine.

In one embodiment, the event detection engine is comprised of a plurality of components, wherein each component uses a different method to detect possible occurrences of the specified event. In one embodiment, the performance assessor maintains a configurable number of configurable alert thresholds for each component.

In one embodiment, the actions are conducted by execution of a respective script. Preferably each script can send signals to the event detection engine to modify the configuration of the event detection engine so as to produce a change in the rate of generation of alerts or false alerts.

In one embodiment, each action includes sending a message to a configuration/administration team.

In one embodiment, a positive transition script is associated with the first upper trigger rate and a negative transaction script is associated with the lower trigger rate. Preferably the positive transition script disables the associated event detection engine component and sends a message to the configuration/administration team. In one embodiment, the negative transition script sends a message to the configuration/administration team.

In one embodiment, the second performance assessor obtains false alert information from an alert investigation team that investigates whether each alert is real or false. In one embodiment, the false alert information includes or is used to derive false art rates. In one embodiment, the moving average is calculated by taking the average of the false negative or false positive rates over a configurable number of configurable periods. In one embodiment, the second performance assessor identifies components within the event detection engine that are generating too many false alerts in response to normal activity or generating too few alerts in response to actual instances of the event.

In one embodiment, the event detection engine detects events by inference. Typically, the event detective engine is a fraud detection engine.

In accordance with a third aspect of the present invention there is provided a performance monitoring and adaptation system for an event detection system comprising: a performance assessor configured to monitor a function of the rate at which false alerts are generated by an event detection system and to perform a second set of actions if the function of the rate crosses a threshold.

In accordance with a fourth aspect of the present invention there is provided an event detection system comprising: an event detection engine that generates an alert if the event is suspected; and a performance assessor configured to monitor a function of the rate at which false alerts are generated by the specified event detection engine and to perform a second set of actions if the function of the rate crosses a threshold.

In accordance with a fifth aspect of the present invention there is provided a method of detecting an event from data comprising: providing an event detection engine for analyzing data for an indication of the event; generating an alert if the event is suspected; monitoring the rate at which alerts are generated by the event detection engine; determining whether the rates crosses a threshold; and if the rates crosses the threshold performing a first set of actions.

In accordance with a sixth aspect of the present invention there is provided a method of detecting an event from data comprising: providing an event detection engine for analyzing data for an indication of the event; generating an alert if the event is suspected; investigating whether the alert is real or false; monitoring the rate at which false alerts are generated by the event detection engine; determining whether the rate of false alerts crosses a threshold; and if the rate of false alerts crosses the threshold performing a second set of actions.

### BRIEF DESCRIPTION OF THE DRAWINGS

In order to provide a better understanding, preferred embodiments of the present invention will now be described with reference to the accompanying drawings, by way of example only, in which:

FIG. 1 is a schematic representation of an indirect event detection system having an automatic performance monitoring and adaptation system according to the present invention; and

FIG. 2 is an example showing hysteresis based threshold triggering based on rates of alert generated by the system of FIG. 1.

### DETAILED DESCRIPTION OF CERTAIN EMBODIMENTS OF THE INVENTION

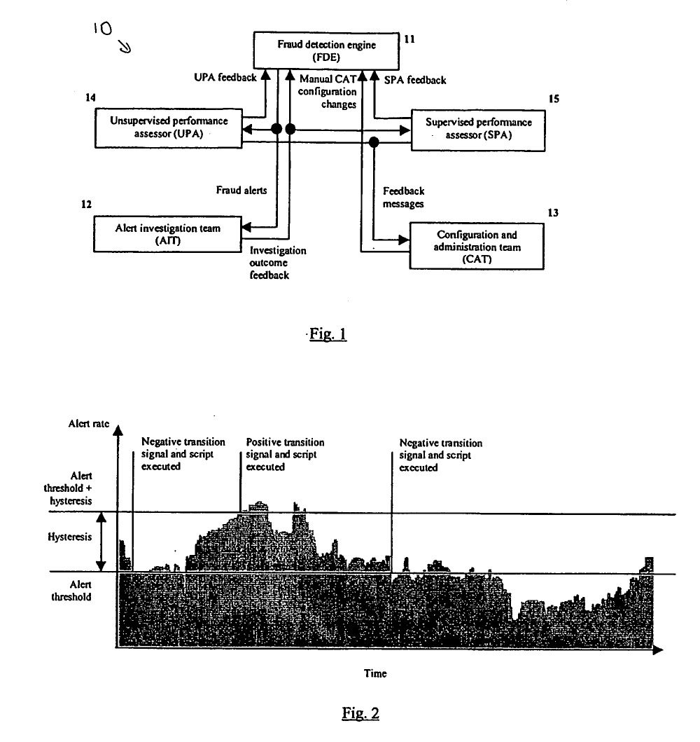

Referring to FIG. 1, there is shown an automatic performance monitoring and adaptation system incorporated into an event detection system 10 which includes an event detection engine 11, an alert investigation team 12, a configuration and administration team 13, an unsupervised performance assessor 14 and a supervised performance assessor 15. The event detection engine 11 is a fraud detection engine used, for example, to indirectly detect fraud, (such as by inference), in a telecommunication network. It provides fraud alert messages to the alert investigation team 12. The alerts are also provided to the unsupervised performance assessor 14 to determine over time the rate of generation of alerts.

The unsupervised performance assessor 14 provides feedback to the fraud detection engine 11 based on the rates of alerts; and provides feedback messages to the configuration and administration team 13, alerting the team 13 of the feedback provided to the engine 11. The alert investigation team 12 investigates fraud alerts and provides feedback based on the outcome of that investigation to the fraud detection engine 11 and the supervised performance assessor 15. The supervised performance assessor 15 uses the investigation outcome feedback to determine rates of generation of false alerts. Based on the assessment of the rates of generation of false alert further feedback is provided by the supervised performance assessor 15 to the fraud detection engine 11. Feedback messages are also provided to the configuration and investigation team 13. Based on the alerts from the unsupervised performance assessor 14 and supervised performance assessor 15, the configuration and administration team 13 provides further manual configuration to the fraud detection engine 11 and components thereof.

The unsupervised performance assessor 14 and the supervised performance assessor 15 may be in the form of a programmed computer or a network of computers that may be independent from or form part of the overall fraud detection system. The unsupervised performance assessor 14 and supervised performance assessor 15 both automatically monitor the performance of individual components within the fraud detection engine 11 and according to the method described above provide so that the feedback is used to modify the behaviour of components of the fraud detection engine 11 to maximise fraud detection performance.

The unsupervised performance assessor 14 monitors the rates at which individual fraud detection engine components generate alerts, and execute scripts to provide the feedback to the fraud detection engine 11 should the rates fall below or rise above acceptable levels set by the configuration and administration team 13. The unsupervised performance assessor 14 estimates the alert rate for each component within the fraud detection engine 11 by counting the number of alerts generated by each component over a configurable period of time. The period should be as long as possible to minimize the random variation in the measured alert rate (which results from the finite size of the sample of alert instances), but as short as possible to minimize the response time of the unsupervised performance assessor 14. In practice a time period of one hour has been found to provide a good trade off between these requirements in systems that monitor call data records in telecommunications networks.

For each fraud detection engine 11 component, the unsupervised performance assessor (UPA) maintains a configurable number of configurable alert rate thresholds. Associated with each threshold is a hysteresis, and a pair of scripts, which control the action taken by the UPA 14 when each threshold is passed as a component's alerts rate either increases or decreases. The script executes when a component's alert rate passes the threshold as it decreases is referred to as the negative transition script. The script executed when the components alert rate passes the other threshold as it increases is referred to as the positive transition script. The hysteresis is provided to reset the triggering of the respective script to stop the positive and negative transition scripts being executed in rapid succession as a result of random variation in a component's alert rate when it lies close to one of the thresholds.

For example, a threshold of 0.001 percent could be defined with a hysteresis of 0.001 percent. A component of the fraud detection engine 11 that starts off with an alert rate of 0.1 percent would not cause either of the scripts associated with the threshold to be executed. If its alert rate fell below the 0.001 percent, however, the negative transition script associated with the threshold would be executed. If the alert rate repeatedly crossed the threshold, the negative transition script would not be re-executed unless the alert rate first rose above the threshold plus the hysteresis (i.e. rose above 0.002 percent), causing the positive transition script to be executed. Thereafter, if the alert rate repeatedly crossed the threshold plus the hysteresis, the positive transition script would not be re-executed unless the alert rate first fell below the threshold. The hysteresis-based operation of the thresholds, and the points of execution of the positive and negative transition scripts is illustrated in FIG. 2.

The scripts can send signals to the fraud detection engine 11 components, and the signals may be used to modify the configurations of these components. Different fraud detection engine 11 components can accept different signals from the scripts, depending on their design and implementation. For example, a change detection algorithm within the fraud detection engine 11 may be able to accept signals instructing it to reduce its sensitivity by a specific amount (for example, by increasing an internal threshold), whereas a neural network may only be able to accept a signal instructing it to disable itself. Alternatively, rather than the change detection algorithm adjusting its sensitivity in response to a signal generated by a script, its sensitivity could be specified explicitly in the algorithm's configuration, and modified directly by the script without any signal being sent to the algorithm itself.

Scripts can also send messages to the configuration and administration team 13 to inform them that alert thresholds have been passed. This provides the team 13 with important information about the performance of individual fraud detection engine 11 components that is useful for maintaining the system's configuration. For example, when the configuration is reviewed by the configuration and administration team 13, the messages sent by the scripts tell the team 13 which components in the original configuration generated too many or too few alerts, and hence need to be modified. A typical application of the unsupervised performance assessor 14 is to define two thresholds: 1) the ‘flood’ threshold, which identifies fraud detection engine 11 components that generate too many alerts, and 2) the ‘drought’ threshold, which identifies fraud detection engine 11 components that generate too few. The flood threshold would be defined to be around 5 percent or so (depending on the rate at which the alert investigation team 12 can process alerts), and the drought threshold to be around 0.001 percent. Hystereses associated with each of 4 and 0.001 percent have been found to work well in practice.

The positive transition script associated with the flood threshold is set to disable the associated fraud detection engine 11 component and send a message to the configuration and administration team 13, as shown below.

```
OnPositiveTransitionOfFloodThreshold ( FDEComponentID )
{
    SendMessage ( ‘Warning: FDE component ‘ FDEComponentID‘ is in
flood and has been disabled’ )
    Disable ( FDEComponentID )
}
```

The negative transition script associated with the drought threshold is set to send a message to the configuration and administration team 13 but to leave the fraud detection engine 11 component enabled below.

OnNegativeTransitionOfDroughtThreshold( FDEComponentID )
{
SendMessage ( ‘Warning: FDE component’ FDEComponentID ‘is
in drought’ )
}

In the pseudo-code, the functions ‘OnPositiveTransitionOfFloodThreshold’ and ‘OnNegativeTransitionOfDroughtThreshold’ are passed to identifiers of the fraud detection engine 11 components responsible for the scripts being invoked. The identifiers are numeric, alphanumeric, or alphabetic strings that are associated with, and unique to, each fraud detection engine 11 component. For example, a change detection component within the fraud detection engine 11 that monitors the cost of calls may be given the identifier ‘ChangeDetector_UniversalCallCost’. The argument of the ‘SendMessage’ function is the string that is to be sent to the configuration and administration team 13. Note that the identifier responsible for the script's execution is inserted into that string in the pseudo-code so that, for example, if the aforementioned change detection algorithm caused the positive flood transition script to be executed, the message ‘Warning: FDE component ChangeDetector_CallCost is in flood and has been disabled’ would be sent to the configuration and administration team.

The negative and positive transition scripts associated with the flood and drought thresholds respectively may be empty (i.e. they do nothing). Alternatively, if the unsupervised performance assessor 14 be configured to disable fraud detection engine 11 components that generate unexpectedly large numbers of alerts, which would swamp the alert investigation team 12 if they were allowed to continue, but only warns the configuration and administration team 13 if a component generates too few alerts so that its configuration can be modified at the next configuration review.

An alternative arrangement could add an additional ‘flood warning’ threshold at around 3 percent, with a hysteresis of 2 percent. By setting its positive transition script to send a warning message to the configuration and administration team 13, the team 13 can be issued with a warning that a fraud detection engine 11 component is at risk of being disabled by the positive transition flood threshold script, allowing time for the team 13 to modify the component's configuration to reduce its alert rate before this occurs.

Monitoring the alert rate of fraud detection engine 11 components with the unsupervised performance assessor 14 is of great practical importance because it allows components that are generating too few or too many alerts to be identified. For example, if a component generates too many alerts, the throughput of the system is reduced by the overhead of processing the alerts and transferring them to the alert investigation team 12. This can cause the fraud detection system to lag behind its input, producing a backlog and robbing the system of its ability to search for fraud in real time. This increases the amount of time that frauds can persist before they are detected and stopped, increasing the revenue lost by the network operator. Any component that generates a large number of alerts is also likely to be generating many more alerts in response to events that are not frauds than those that are, and is thus a poor fraud detector. The overall fraud detection performance of the system could therefore be improved by modifying the configuration of the component or removing it altogether.

A fraud detection engine 11 component that generates too few alerts is also problematic, because the resources it uses within the system may not be justified by its fraud detection abilities. (For example, this is certainly the case for a component that never generates alerts.) Such components can usually operate at higher sensitivities without generating an excessive number of alerts, while also offering increased speed and strength of response to actual fraud events. Alternatively, the performance of the system can sometimes be improved if these components are removed completely because the increase in throughput that results can increase the speed at which frauds are detected, thus reducing the revenue lost by the network operator before the fraud is stopped. By allowing the unsupervised performance assessor 14 to execute configurable scripts when the alert rates of individual fraud detection engine 11 components rise above, or fall below, configurable thresholds, the assessor 14 can respond to changes in the alert rates of individual fraud detection engine 11 components far faster than can the configuration and administration team 13. A fraud detection system with a UPA-type mechanism is thus able to respond to changes in its environment, far more quickly than one without.

The supervised performance assessor (SPA) 15 is similar to the unsupervised performance assessor 14, except that the supervised performance assessor 15 uses feedback provided by the alert investigation team 12 to maintain statistics on, and apply thresholds to, a function of the false positive and false negative rates of fraud detection engine 11 components. A false positive occurs when a fraud detection engine 11 component generates an alert that, upon investigation by the alert investigation team 12 turns out not to be associated with a real fraud. Conversely, a false negative occurs when a fraud detection engine 11 component fails to generate an alert for an event that was part of a fraud. Thresholds within the supervised performance assessor 15 are defined on the function of the false negative and false positive rates of fraud detection engine 11 components, and trigger the execution of scripts in the same way as scripts are triggered within the unsupervised performance assessor 14. The function of the false negative and false positive rates of fraud detection engine 11 components are moving averages of their false negative and false positive rates over a configurable number of configurable periods. For example, a period of one day is often chosen as the configurable period, and the moving average is taken over a fourteen day window of such periods.

Like the unsupervised performance assessor 14, the supervised performance assessor 15 has an important role to play in maintaining good fraud detection performance within the system by identifying components within the fraud detection engine 11 that are generating too many fraud alerts in response to normal activity, or generating too few alerts in response to fraud. The former are problematic because they use system resources—particularly those of the alert investigation team 13—to search for fraudulent activity that does not exist. This increases the amount of time that the team 12 takes to identify the real frauds, and hence increases the revenue lost by the network operator to the fraudsters before the fraud is stopped. If a fraud detection engine 11 component generates too few alerts in response to real frauds, it is likely that its sensitivity could be increased, with the result that it responds more rapidly to real fraud events. The SPA's ability to automatically execute scripts in response to false positive and false negative alert rate moving averages crossing thresholds means that it can adapt the fraud detection engine 11 components far more rapidly to changing conditions than can a fraud detection system that relies on human intervention.

The skilled addressee will realise that the present invention provides advantages over existing fraud detection systems that do not have a performance assessor automatically monitoring the performance of the fraud detection engine. The overall systems performance in terms of fraud detection sensitivity, and throughput, may be maximised as well as minimizing the number of false alerts sent to the alert investigation team.

Modifications and variations may be made to the present invention without departing from the basic inventive concept. Such modifications may include adapting the system to other specified event detection circumstances. The alert investigation team and configuration and administration team may overlap or be the same unit. The alert investigation team and/or configuration/administration team may be partly or wholly automated or include expert systems. Such modifications and variations and intended to fall within the scope of the present invention, the nature of which is to be determined by the foregoing description.

1. A performance monitoring and adaptation system for an event detection system having an event detection engine, comprising:
a performance assessor configured to monitor the rate at which alerts are generated by the event detection engine and to perform a first set of actions if the rate crosses a threshold in a first direction and perform a second set of actions if the rate crosses the threshold in a second direction.

2. An event detection system, comprising:
an event detection engine that generates an alert if an event is suspected; and
a performance assessor configured to monitor the rate at which alerts are generated by the event detection engine and to perform a first set of actions if the rate crosses a threshold in a first direction and perform a second set of actions if the rate crosses the threshold in a second direction.

3. An event detection system, comprising:
an event detection engine that generates an alert if an event is suspected; and
a performance assessor configured to monitor the rate at which false alerts are generated by the event detection engine and to perform a first set of actions if the function of the rate crosses a threshold in a first direction and perform a second set of actions if the function of the rate crosses the threshold in a second direction.

4. A performance monitoring and adaptation system for an event detection system, comprising:
a performance assessor configured to monitor a function of the rate at which false alerts are generated by an event detection system and to perform a first set of actions if the function of the rate crosses a threshold in a first direction and perform a second set of actions if the function of the rate crosses the threshold in a second direction.

5. A method of detecting an event from data, comprising:
providing an event detection engine which analyzes data for an indication of an event;
generating an alert if the event is suspected;
monitoring the rate at which alerts are generated by the event detection engine;
determining whether the rate crosses a threshold and the direction of crossing the threshold;
in the event that the rate crosses the threshold in a first direction performing a first set of actions; and
in the event that the rate crosses the threshold in a second direction performing a second set of actions.

6. A method of detecting an event from data, comprising:
providing an event detection engine which analyzes data for an indication of an event;
generating an alert if the event is suspected;
investigating whether the alert is real or false;
monitoring the rate at which false alerts are generated by the event detection engine;
determining whether the rate of false alerts crosses a threshold and the direction of crossing the threshold;
in the event that the rate of false alerts crosses the threshold in a first direction performing a first set of actions; and
in the event that the rate of false alerts crosses the threshold in a second direction performing a second set of actions.

7. A performance monitoring and adaptation system for an event detection system having an event detection engine, comprising:
a first performance assessor configured to monitor the rate at which alerts are generated by the event detection engine and to perform a first set of actions if the rate crosses a threshold;
an alert investigation section configured to identify whether the alert is a false alert; and
a second performance assessor configured to monitor the rate at which false alerts are generated by the event detection engine to perform a second set of actions if the rate of false alerts crosses a second threshold.

8. An event detection system, comprising:
an event detection engine that generates an alert if an event is suspected;
an alert investigation section configured to identify whether the alert is a false alert;
a first performance assessor configured to monitor the rate at which alerts are generated by the event detection engine and to perform a first set of actions if the rate crosses a first threshold; and
a second performance assessor configured to monitor the rate at which false alerts are generated by the event detection engine and to perform a second set of actions if the rate of false alerts crosses a second threshold.

9. A method of detecting an event from data, comprising:
providing an event detection engine which analyzes data for an indication of an event;
generating an alert if the event is suspected;
identifying whether the alert is a false alert;
monitoring the rate at which alerts are generated by the event detection engine;
determining whether the rate crosses a first threshold;
in the event that the rate crosses the threshold performing a first set of actions;
monitoring the rate at which false alerts are generated by the event detection system engine; and
determining whether the rate of false alerts crosses a second threshold and in the event of the rate crossing the second threshold performing a second set of actions.

10. A performance monitoring and adaptation system for an event detection system, comprising:
a performance assessor configured to monitor the rate at which alerts are generated by an event detection system and to perform a first set of actions if the rate crosses a threshold, wherein further performing of the first set of actions upon crossing of the threshold is disabled until the rate crosses the threshold again in the opposite direction and a reset threshold is reached.

11. An event detection system, comprising:
an event detection engine that generates an alert if an event is suspected; and
a performance assessor configured to monitor the rate at which alerts are generated by the event detection engine and to perform a first set of actions if the rate crosses a threshold, wherein further performing of the first set of actions upon crossing of the threshold is disabled until the rate crosses the threshold again in the opposite direction and a reset threshold is reached.

12. An event detection system, comprising:
an event detection engine that generates an alert if an event is suspected; and
a performance assessor configured to monitor a function of the rate at which false alerts are generated by the event detection engine and to perform a first set of actions if the function of the rate crosses a threshold,
wherein further performing of the first set of actions upon crossing of the threshold is disabled until the rate crosses the threshold again in the opposite direction and a reset threshold is reached.

13. A method of detecting an event from data, comprising:
providing an event detection engine which analyzes data for an indication of an event;
generating an alert if the event is suspected;
monitoring the rate at which alerts are generated by the event detection engine;
determining whether the rates crosses a threshold and in the event that the rate crosses the threshold performing a set of actions; and
disabling further performing of the set of actions until the rate crosses the threshold again in the opposite direction and a reset threshold is reached.

14. A method of detecting an event from data, comprising:
providing an event detection engine which analyzes data for an indication of an event;
generating an alert if the event is suspected;
investigating whether the alert is real or false;
monitoring the rate at which false alerts are generated by the event detection engine;
determining whether the rate of false alerts crosses a threshold and in the event that the rate of false alerts crosses the threshold performing a set of actions; and
disabling further performing of the set of actions until the rate crosses the threshold again in the opposite direction and a reset threshold is reached.

15. A performance monitoring and adaptation system for an event detection system having an event detection engine, comprising:
a performance assessor configured to monitor the rate at which alerts are generated by an event detection engine and to perform a first set of actions if the rate crosses a threshold, wherein the first set of actions modifies the event detection engine or a respective parameter of the event detection engine so as to tune the accuracy of the event detection engine at generating alerts.

16. An event detection system, comprising:
an event detection engine that generates an alert if an event is suspected; and
a performance assessor configured to monitor the rate at which alerts are generated by the event detection engine and to perform a first set of actions if the rate crosses a threshold, wherein the first set of actions modifies the event detection engine or a respective parameter of the event detection engine so as to tune the accuracy of the event detection engine at generating alerts.

17. An event detection system, comprising:
an event detection engine that generates an alert if an event is suspected; and
a performance assessor configured to monitor a function of the rate at which false alerts are generated by the event detection engine and to perform a first set of actions if the function of the rate crosses a threshold, wherein the first set of actions modifies the event detection engine or a respective parameter of the event detection engine so as to tune the accuracy of the event detection engine at generating alerts.

18. A performance monitoring and adaptation system for an event detection system, comprising:
a performance assessor configured to monitor a function of the rate at which false alerts are generated by an event detection system and to perform a first set of one or more actions if the function of the rate crosses a threshold in a first direction and perform a second set of one or more actions if the function of the rate crosses the threshold in a second direction, wherein the first set of actions modifies the event detection engine or a respective parameter of the event detection engine so as to tune the accuracy of the event detection engine at generating alerts.

19. A method of detecting an event from data, comprising:
providing an event detection engine which analyzes data for an indication of an event;
generating an alert if the event is suspected;
monitoring the rate at which alerts are generated by the event detection engine; and
determining whether the rates crosses a threshold and in the event that the rates cross the threshold performing a set of actions,
wherein the first set of actions modifies the event detection engine or a respective parameter of the event detection engine so as to tune the accuracy of the event detection engine at generating alerts.

20. A method of detecting an event from data, comprising:
providing an event detection engine which analyzes data for an indication of an event;
generating an alert if the event is suspected;
investigating whether the alert is real or false;
monitoring the rate at which false alerts are generated by the event detection engine;
determining whether the rate of false alerts crosses a threshold; and
in the event that the rate of false alerts crosses the threshold performing a set of actions,
wherein the first set of actions modifies the event detection engine or a respective parameter of the event detection engine so as to tune the accuracy of the event detection engine at generating alerts.

21. A system according to claim 1, wherein the performance assessor is configured to disable further performing of the first set of actions due to crossing of the threshold until the rate crosses the threshold again in the opposite direction and a reset threshold is reached.

22. A system according to claim 1, wherein the threshold is an end of a configurable range, and wherein the first set of actions is triggered if the rate falls outside of the range.

23. A system according to claim 1, wherein the threshold is an end of a configurable range, wherein the first set of actions is triggered if the rate falls outside of the range, and wherein the second set of actions is triggered if the rate falls inside the range.

24. A system according to claim 1, wherein a configurable number of thresholds may be provided, each of which triggers a respective set of actions if the rate of alerts crosses the respective threshold.

25. A system according to claim 1, wherein the second set of actions includes no action, or one or more actions.

26. A system according to claim 7, wherein the first set of actions is triggered by the rate crossing the threshold in a first direction and the second set of actions is triggered by the rate crossing the threshold in a second direction.

27. A system according to claim 1, further comprising a means for identifying whether the alert is a false alert and a second performance assessor configured to monitor the rate at which false alerts are generated by the event detection system to perform a third set of actions if the rate of false alerts crosses a second threshold.

28. A system according to claim 27, wherein the second threshold is an end of a second configurable range, wherein the third set of actions is triggered if the rate of false alerts falls outside the second configurable range.

29. A system according to claim 27, wherein the second threshold is an end of a second configurable range, wherein the third set of actions is triggered if the rate of false alerts falls inside the second configurable range.

30. A system according to claim 27, wherein a configurable number of thresholds may be provided, each of which triggers a respective set of actions if the rate of false alerts crosses the respective threshold.

31. A system according to claim 7, wherein a third set of actions is triggered by the rate of false alerts crossing the second threshold in a first direction and a fourth set of actions is triggered by the rate of false alerts crossing the second threshold in a second direction.

32. A system according to claim 22, wherein the first set of actions includes a first alert flood action conducted when the rate of alerts crosses above a configurable first upper trigger rate.

33. A system according to claim 22, wherein the first set of actions includes a first drought action which occurs when the rate of alerts crosses below a first configurable lower trigger rate.

34. A system according to claim 26, wherein the second set of actions includes a second alert flood action which is triggered when a function of the false alert rate rises above a configurable second upper trigger rate.

35. A system according to claim 26, wherein the second set of actions includes a second alert drought action which is triggered when a function of the rate of false alerts falls under a configurable second lower trigger rate.

36. A system according to claim 1, wherein the first set of actions modifies the event detection engine.

37. A system according to claim 1, wherein the first set of actions modifies a respective parameter of the event detection engine.

38. A system according to claim 1, wherein the first set of actions includes sending a message to a configuration and/or administration team.

39. A system according to claim 7, wherein the second performance assessor obtains false alert statistics from an alert investigation team that investigates whether an alert is real or false.

40. A method according to claim 5, further performing of the first set of actions upon crossing of the threshold is disabled until the rate crosses the threshold again in the opposite direction and a reset threshold is reached.

41. A method according to claim 9, wherein the threshold is an end of a configurable range, and wherein the first set of actions is triggered if the rate falls outside of the range.

42. A method according to claim 5, wherein the threshold is an end of a configurable range, wherein the first set of actions is triggered if the rate falls outside of the range, and wherein the second set of actions is triggered if the rate falls inside the range.

43. A method according to claim 5, wherein a configurable number of thresholds may be provided, each of which triggers a respective set of actions if the rate of alerts crosses the respective threshold.

44. A method according to claim 5, wherein the second set of actions includes no action or one or more actions.

45. A method according to claim 9, wherein the first set of actions is triggered by the rate crossing the threshold in a first direction and the second set of actions is triggered by the rate crossing the threshold in a second direction.

46. A method according to claim 5, further comprising identifying whether the alert is a false alert and monitoring the rate at which false alerts are generated by the event detection system, and performing a third set of actions if the rate of false alerts crosses a second threshold.

47. A method according to claim 46, wherein the second threshold is an end of a second configurable range, and wherein the third set of actions is triggered if the rate of false alerts falls outside the second configurable range.

48. A method according to claim 46 wherein the second threshold is an end of a second configurable range, and wherein the third set of actions is triggered if the rate of false alerts falls inside the second configurable range.

49. A method according to claim 46, wherein a configurable number of thresholds may be provided, each of which triggers a respective set of actions if the rate of false alerts crosses the respective threshold.

50. A method according to claim 9, wherein a third set of actions is triggered by the rate of false alerts crossing the second threshold in a first direction and a fourth set of alerts is triggered by the rate of false alerts crossing the second threshold in a second direction.

51. A method according to claim 41, wherein the first set of actions includes a first alert flood action conducted when the rate of alerts crosses above a configurable first upper trigger rate.

52. A method according to claim 41, wherein the first set of actions includes a first drought action which occurs when the rate of alerts crosses below a first configurable lower trigger rate.

53. A method according to claim 45, wherein the second set of actions includes a second alert flood action which is triggered when a function of the false alert rate rises above a configurable second upper trigger rate.

54. A method according to claim 45, wherein the second set of actions includes a second alert drought action which is triggered when a function of the rate of false alerts falls under a configurable second lower trigger rate.

55. A method according to claim 5, wherein the first set of actions modifies the event detection engine.

56. A method according to claim 5, wherein the first set of actions modifies a respective parameter of the event detection engine.

57. An event detection system, comprising:
means for providing an event detection engine which analyzes data for an indication of an event;
means for generating an alert if the event is suspected;
means for monitoring the rate at which alerts are generated by the event detection engine;
means for determining whether the rate crosses a threshold and the direction of crossing the threshold;
means for, in the event that the rate crosses the threshold in a first direction, performing a first set of actions; and
means for, in the event that the rate crosses the threshold in a second direction, performing a second set of actions.
